(19) United States
(12) Patent Application Publication
(10) Pub. No.: US 2002/0166444 A1
(43) Pub. Date: Nov. 14, 2002

(54) Compressor head

(76) Inventor: Matthias Remke, Starnberg (DE)

Correspondence Address: MERCHANT & GOULD PC, P.O. BOX 2903, MINNEAPOLIS, MN, 55402-0903, US

(21) Appl. No.: 09/999,213

(22) Filed: Nov. 30, 2001

(30) Foreign Application Priority Data
Nov. 30, 2000 (DE) 100 59 473.5

(51) Int. Cl. F15B 11/08

(52) U.S. Cl. 91/468

(57) ABSTRACT

The present invention refers to a compressor head according to German Patent 199 27 458.4, wherein the valve elements are multiple-beak valves, the slot-shaped valve openings of which are arranged at right angles to each other.

The present invention refers to a compressor head according to German Patent 199 27 458.4, filed on Jun. 16, 1999, and having the title “compressor head”.

As described in German Patent 199 27 458.4, the invention proceeds from the following state of the art.

There are known various compressors and pumps which compress a liquid or gaseous medium in a compression space. In known piston compressors or diaphragm pumps, the volume of a compression space is varied periodically by means of an oscillating movement of a piston closing the compression space. The inflow of the medium to be compressed into the compression space and the outflow of the compressed medium from the compression space is controlled by means of corresponding valves which, normally, are of a disk-like or flap-shaped design.

For instance from U.S. Pat. No. 5,092,224 there is known a compressor arrangement which comprises an air inlet chamber, an air outlet chamber and a compression chamber. The air inlet chamber and the air outlet chamber are separated from each other and are connected via a valve to the compression chamber, respectively, the volume of which is increased or reduced by the periodical movement of a piston. The employed valves, each of which enable or prevent an inflow or outflow of air in an intended manner, are of a flap-shaped design. During a suction process, i.e. when the compressor space volume increases, the opening between the air inlet chamber and the compression chamber is unblocked by means of the disk-shaped valve element secured on one side by means of a screw or bolt in that this valve element is lifted on one side. At the same time, another valve element closes the opening between the compression chamber and the air outlet chamber. During the compression process, i.e. when the volume of the compression chamber is reduced, the opening between the air inlet chamber and the compression chamber is closed, and simultaneously a valve element unblocks the opening between the air outlet chamber and the compression chamber, so that the compressed medium flows out of the compression chamber into the air outlet chamber.

Similar outlet and inlet valves of a flap-shaped design are described in U.S. Pat. No. 3,961,868. Also here corresponding inlet and outlet openings are closed by means of elastic valve elements and are opened by lifting said elastic valve elements. For this, the elastic valve elements are mounted on one side by means of screws at corresponding parts of the compressor so that the elastic valve element is lifted on one side when the opening is unblocked and rests upon the opening and the surrounding region when it is closed.

The openings between corresponding inlet chambers, outlet chambers and compressor chambers may also comprise elastic valve elements which are designed such that the disk-shaped valve elements are not only fixed on one side but at several locations, for instance symmetrically around the opening. An opening or closing is carried out by lifting the entire elastic valve element perpendicularly to the surface of the opening. When, for instance, a gaseous or liquid medium penetrates from below into an opening blocked by means of such a valve element, the entire valve element is lifted due to said flow and the medium exits through said opening. When the gaseous or liquid medium flows from the opposite side in the direction towards the valve element blocking the opening, the valve element is pressed against the opening due to said flow and closes the same.

The known valve elements are made for instance of plastics, rubber, silicone or any other flexible synthetic material. During the compression process the valve elements are opened and closed periodically. Such a periodical opening and closing results in an enormous generation of noise, as each time when an opening is blocked, the disk-shaped valve element bumps on the region surrounding the opening and serving as valve seat which, for example, consists of metal or a synthetic material. Thus, during the periodical opening and closing, different materials with a low elasticity impact upon one another. Furthermore, in the known arrangements normally the bearing area, i.e. the surface of contact of the valve element with the region surrounding the opening, is relatively large. This has also a negative effect on the noise generation.

Such a high noise generation is unwanted in particular in compressors which are used with inhalation therapy devices. For a patient which uses such an inhalation therapy device, a high noise level is quite unpleasant.

The invention described in German Patent 199 27 458.4 solves the problem to provide a compressor head in which the noise generation during the periodical compression process is substantially reduced, without deteriorating the operational characteristics of the compressor.

This object is solved according to German Patent 199 27 458.4 by a compressor head with a compression space, a first expansion chamber having an inlet connecting piece and a first valve element via which the first expansion chamber is connected to the compression space, and a second expansion chamber having an outlet connecting piece and a second valve element via which the second expansion chamber is connected to the compression space, wherein the valve elements are elastic beak valves.

Further embodiments follow from the subclaims of German Patent 199 27 458.4.

The object of the present invention is to further improve the compressor head described in German Patent 199 27 458.4.

Said object is achieved in accordance with the present invention by a compressor head according to German Patent 199 27 458.4 in which the valve elements are elastic multiple-beak valves.

In an advantageous development, the valve elements are elastic double-beak valves, the slot-shaped valve openings of which are arranged at right angles to each other.

In the following, the invention is described in more detail by means of the drawings, wherein

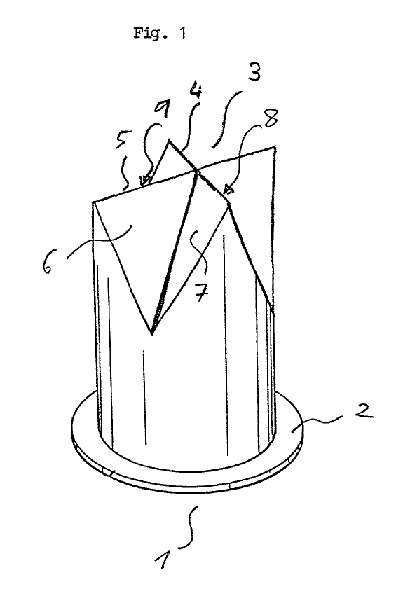

FIG. 1 shows a cross-beak valve according to the invention; and

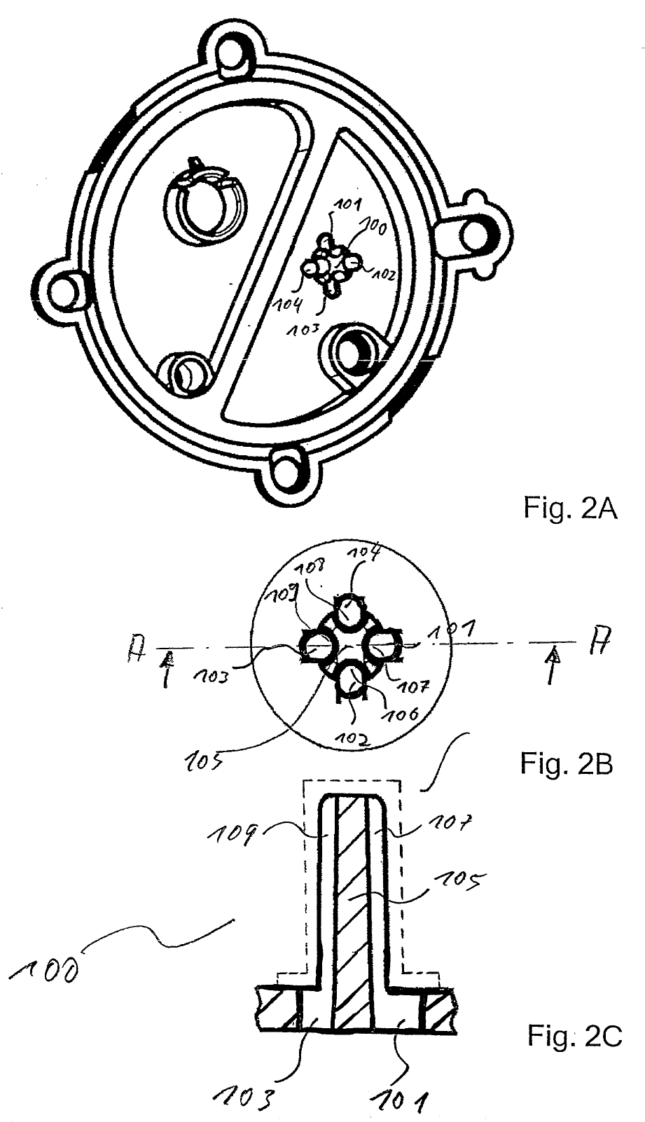

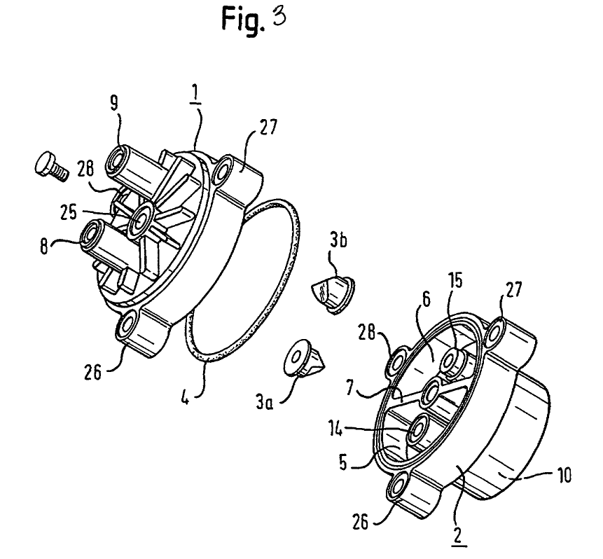

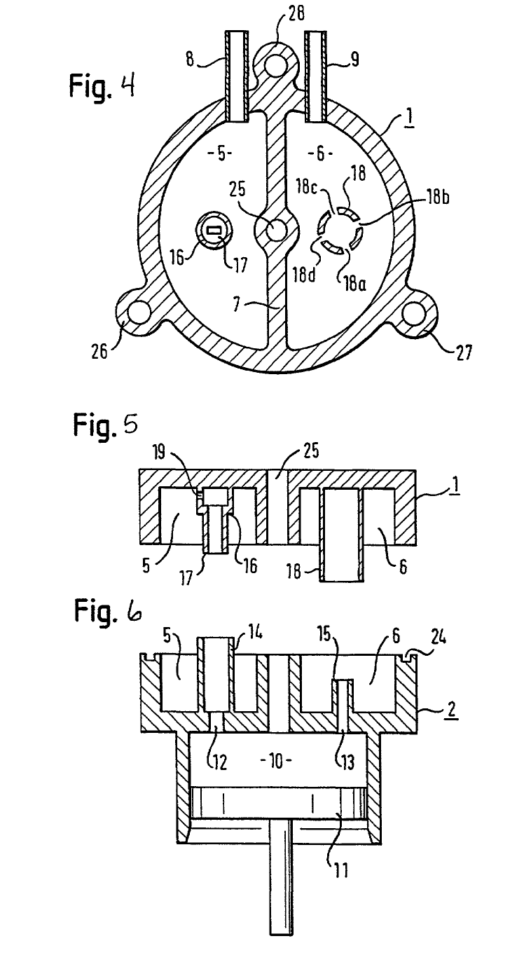

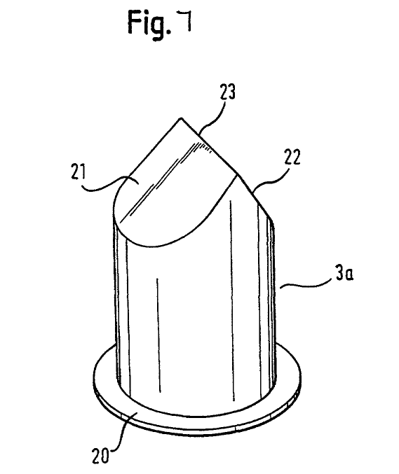

FIG. 2A-C show a valve seat for an inventive cross-beak valve.

In FIG. 1 there is shown a double-beak valve which can be inserted according to the invention into a compressor head for inhalation therapy devices. It is arranged at the inlet and/or outlet connecting piece of the relaxation chamber instead of the beak valve as described in German Patent 199 27 458.4, included herein by reference.

The double-beak valve shown in FIG. 1 is for instance made of rubber or another elastic synthetic material and has a cylindrical end 1 with a circular opening. The cylindrical end 1 is surrounded by a plate-shaped rim 2. The opposite end 3 of the double-beak valve has two valve opening edges 4 and 5 arranged crosswise. In the rest position, both valve opening edges 4 and 5 are closed, as is shown in FIG. 1. When compressed air flows into the cylindrical end 1 of the double-beak valve according to FIG. 1, the valve openings open along the edges 4 and 5 by spreading open the valve wings 6, 7, 8, and 9, of which, however, only the valve wings 6 and 7 are immediately visible in FIG. 1.

In FIG. 2A there is shown a perspective view of a compressor head part of an inhalation therapy device compressor in which a valve seat 100 is formed for a cross double-beak valve. The valve seat 100 comprises four openings 101-104 which are arranged crosswise in pairs opposite to each other. The position of the openings 101-104 can be seen also in FIG. 2B which represents a top view of the valve seat 100 according to FIG. 2A. In FIG. 2B, the core 105 of the valve seat 100 is clearly to be recognized which is also shown in FIG. 2C. FIG. 2C shows a sectional view of the valve seat 100 along line A-A in FIG. 2B. Also the openings 101 and 103 lying opposite to each other can be seen here. In the region of the core part, the passage openings 101-104 are continued in the form of grooves or longitudinal slots 106, 107, 108, and 109 which are also arranged in pairs crosswise and opposite to each other and extend along the core part. In FIG. 2C there can be seen the longitudinal slots 107 and 109.

The inventive double-beak valve is attached on the valve seat 100 and is fixed by the valve seat. In FIG. 2C, the outer contour of the cross-beak valve slipped on the valve seat is indicated by a broken line. The cross-beak valve receives the valve seat 100 at is cylindrical end 1. The sealing is obtained by the plate-shaped rim or shoulder 2. The plate-shaped rim 2 becomes unnecessary when the valve seat according to German Patent 199 27 458.4, which is included herein by reference, is chosen, as then the cylindrical end tightly encloses the valve seat.

In the valve seat 100 as shown in FIGS. 2A through 2C, the flow of the pressure medium is effectively supported, as the two valve opening edges 4 and 5 of the double-beak valve according to the invention are aligned congruently in accordance with the position of the longitudinal slots and openings. Alternatively to said positioning of the double-beak valve according to the invention, also an arrangement rotated by 45° can be chosen so that the edges 4 and 5 of the valve openings are congruently aligned with the edges of the core part 105. It is, however, advantageous to choose one of said two positions, as thereby a pressure medium flow exploiting the symmetry of the cross-beak valve according to FIG. 1 is obtained.

What is claimed is:

1. A compressor head according to anyone of the claims of German Patent 199 27 458.4, characterized in that the valve elements are elastic multiple-beak valves.

2. The compressor head according to claim 1, characterized in that the valve elements are cross-beak valves.

3. The compressor head according to claim 1 or 2, characterized by a valve seat (100) which has four passage openings (101, 102, 103, 104) being arranged in pairs opposite to each other and crosswise, which are placed around a core part (105).

4. The compressor head according to claim 3, characterized in that the core part (105) of the valve seat (100) has longitudinal slots for the continuation of the passage openings (101, 102, 103, 104).
